(19) United States
(12) Patent Application Publication
(10) Pub. No.: US 2026/0129456 A1
(43) Pub. Date: May 7, 2026

(54) MISBEHAVIOR DETECTION AND VERIFICATION USING ENVIRONMENT MAPPING

(71) Applicant: Technology Innovation Institute - Sole Proprietorship LLC, Khalifa City (AE)

(72) Inventors: Mohit Kumar Sharma, Abu Dhabi (AE); Anuj Abraham, Abu Dhabi (AE); Wassim Hamidouche, Abu Dhabi (AE)

(73) Assignee: Technology Innovation Institute - Sole Proprietorship LLC, Khalifa City (AE)

(21) Appl. No.: 19/370,912

(22) Filed: Oct. 28, 2025

Related U.S. Application Data
(60) Provisional application No. 63/714,993, filed on Nov. 1, 2024.

(51) Int. Cl. H04W 12/65; H04W 4/38; H04W 4/44; H04W 12/069; H04W 12/082

(52) U.S. Cl. CPC H04W 12/65; H04W 4/38; H04W 4/44; H04W 12/069; H04W 12/082

(57) ABSTRACT

A system for vehicular misbehavior detection, comprising: a vehicular network, and a misbehavior authority in communication with vehicles in the vehicular network, the misbehavior authority configured to receive a misbehavior report from at least one of the vehicles in the vehicular network, the misbehavior report based on a determined discrepancy between a collective perception message (CPM) received from a malicious vehicle and sensor data of the at least one of the vehicles, receive sensor data from the vehicles in the vehicular network, generate an environment map based on the sensor data received from the vehicles in the vehicular network, analyze the misbehavior report by comparing information in the misbehavior report with the generated environment map, and initiate a certificate revocation process for the malicious vehicle if the misbehavior report is verified.

### CROSS-REFERENCE TO RELATED APPLICATION

This application claims priority to U.S. Provisional Application No. 63/714,993, filed Nov. 1, 2024, which is incorporated by reference in its entirety.

### FIELD

The present disclosure generally relates to misbehavior detection and verification in vehicular communication networks. In one example, the systems and methods identify and validate potential misbehavior in Cellular Vehicle-to-Everything (C-V2X) environments through the use of dynamically generated environment maps.

### BACKGROUND

Cellular Vehicle-to-Everything (C-V2X) technology has emerged as a promising solution for enhancing road safety, traffic efficiency, and overall transportation system performance. C-V2X enables vehicles to communicate with each other, pedestrians, infrastructure, and network systems, facilitating the exchange of beneficial information such as vehicle position, speed, and road conditions. This technology relies on a combination of direct short-range communications and cellular network infrastructure to create a comprehensive and reliable vehicular communication ecosystem. Current C-V2X systems employ various security measures, including cryptography-based solutions and public key infrastructure (PKI) systems, to authenticate vehicles and protect against external threats.

Despite these security measures, C-V2X networks remain vulnerable to attacks launched by malicious insiders who are already authenticated and part of the system. These insider threats can manipulate or falsify data payloads in messages such as Basic Safety Messages (BSM), Cooperative Awareness Messages (CAM), and Collective Perception Messages (CPM), potentially compromising the integrity of the network. Existing authentication systems struggle to detect and mitigate these internal attacks, which can lead to severe consequences in terms of road safety and traffic management. Additionally, the current approaches to misbehavior detection often lack the ability to independently verify reported incidents, making it challenging to distinguish between genuine threats and false alarms in real-time vehicular environments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, the present disclosure relates to a system for vehicular misbehavior detection, comprising a vehicular network, and a misbehavior authority in communication with vehicles in the vehicular network, the misbehavior authority configured to receive a misbehavior report from at least one of the vehicles in the vehicular network, the misbehavior report based on a determined discrepancy between a collective perception message (CPM) received from a malicious vehicle and sensor data of the at least one of the vehicles, receive sensor data from the vehicles in the vehicular network, generate an environment map based on the sensor data received from the vehicles in the vehicular network, analyze the misbehavior report by comparing information in the misbehavior report with the generated environment map, and initiate a certificate revocation process for the malicious vehicle if the misbehavior report is verified.

In embodiments of this aspect, the disclosure according to the above example embodiment is provided, wherein the sensor data received from the vehicles in the vehicular network includes at least one of radio frequency (RF) signals, video data, radar data, and intra-sensor communication signals.

In embodiments of this aspect, the disclosure according to any one of the above example embodiments is provided, wherein generating the environment map comprises using a deep learning-based tomography technique to process the sensor data received from the vehicles in the vehicular network.

In embodiments of this aspect, the disclosure according to the above example embodiment is provided, wherein analyzing the misbehavior report comprises creating a first bounding box based on the generated environment map, creating a second bounding box based on information in the misbehavior report, and calculating an Intersection over Union (IoU) metric between the first and second bounding boxes.

In embodiments of this aspect, the disclosure according to the above example embodiment is provided, wherein analyzing the misbehavior report further comprises comparing the calculated IoU metric against a predefined confidence threshold.

In embodiments of this aspect, the disclosure according to the above example embodiment is provided, wherein analyzing the misbehavior report comprises reconstructing the CPM based on the generated environment map, comparing the reconstructed CPM with the CPM received from the vehicle reporting misbehavior, and determining if an attack has occurred based on the comparison.

In embodiments of this aspect, the disclosure according to the above example embodiment is provided, wherein comparing the reconstructed CPM with the received CPM comprises calculating a weighted sum of differences between corresponding fields in the reconstructed CPM with the received CPM.

In embodiments of this aspect, the disclosure according to the above example embodiment is provided, wherein the misbehavior authority is further configured to broadcast an updated CPM message to other vehicles in the vehicular network after initiating the certificate revocation process.

In embodiments of this aspect, the disclosure according to the above example embodiment is provided, wherein the misbehavior authority is integrated within a 5G core network.

In embodiments of this aspect, the disclosure according to the above example embodiment is provided, wherein initiating the certificate revocation process comprises sending a revoke request to a Session Management Function (SMF) in the 5G core network.

In other aspects, the present disclosure relates to a method for vehicular misbehavior detection, comprising receiving, by a misbehavior authority in communication with vehicles in a vehicular network, a misbehavior report from at least one of the vehicles in the vehicular network, the misbehavior report based on a determined discrepancy between a collective perception message (CPM) received from a malicious vehicle and sensor data of the at least one of the vehicles, receiving, by the misbehavior authority, sensor data from the vehicles in the vehicular network, generating, by the misbehavior authority, an environment map based on the sensor data received from the vehicles in the vehicular network, analyzing, by the misbehavior authority, the misbehavior report by comparing information in the misbehavior report with the generated environment map, and initiating, by the misbehavior authority, a certificate revocation process for the malicious vehicle if the misbehavior report is verified.

In embodiments of these other aspects, the disclosure according to the above example embodiment is provided, wherein the sensor data received from the vehicles in the vehicular network includes at least one of radio frequency (RF) signals, video data, radar data, and intra-sensor communication signals.

In embodiments of these other aspects, the disclosure according to the above example embodiment is provided, wherein generating the environment map comprises using a deep learning-based tomography technique to process the sensor data received from the vehicles in the vehicular network.

In embodiments of these other aspects, the disclosure according to the above example embodiment is provided, wherein analyzing the misbehavior report comprises creating a first bounding box based on the generated environment map, creating a second bounding box based on information in the misbehavior report, and calculating an Intersection over Union (IoU) metric between the first and second bounding boxes.

In embodiments of these other aspects, the disclosure according to the above example embodiment is provided, wherein analyzing the misbehavior report comprises comparing the calculated IoU metric against a predefined confidence threshold.

In embodiments of these other aspects, the disclosure according to the above example embodiment is provided, wherein analyzing the misbehavior report comprises reconstructing the CPM based on the generated environment map, comparing the reconstructed CPM with the CPM received from the vehicle reporting misbehavior, and determining if an attack has occurred based on the comparison.

In embodiments of these other aspects, the disclosure according to the above example embodiment is provided, wherein comparing the reconstructed CPM with the received CPM comprises calculating a weighted sum of differences between corresponding fields in the reconstructed CPM with the received CPM.

In embodiments of these other aspects, the disclosure according to the above example embodiment is provided, wherein the method further comprises broadcasting, by the misbehavior authority, an updated CPM message to other vehicles in the vehicular network after initiating the certificate revocation process.

In embodiments of these other aspects, the disclosure according to the above example embodiment is provided, wherein the misbehavior authority is integrated within a 5G core network.

In embodiments of these other aspects, the disclosure according to the above example embodiment is provided, wherein initiating the certificate revocation process comprises sending a revoke request to a Session Management Function (SMF) in the 5G core network.

The foregoing general description of the illustrative embodiments and the following detailed description thereof are merely exemplary aspects of the teachings of this disclosure and are not restrictive.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 illustrates a system overview of a vehicular communication network, according to aspects of the present disclosure.

FIG. 2 illustrates a side view of a vehicle with internal electronic components, according to an embodiment.

FIG. 3 illustrates a block diagram of a Collective Perception Message structure, according to aspects of the present disclosure.

FIG. 4 illustrates a flowchart of a process for generating and transmitting a Collective Perception Message, according to an embodiment.

FIG. 5A illustrates a system overview of a vehicular communication and misbehavior detection system, according to aspects of the present disclosure.

FIG. 5B illustrates a flowchart for a process of detecting and responding to misbehavior in a vehicular network, according to an embodiment.

FIG. 6 illustrates a block diagram of network architecture layers for a vehicular communication system, according to aspects of the present disclosure.

FIG. 7A illustrates a bounding box illustration for a vehicle detection system, according to an embodiment.

FIG. 7B illustrates a flowchart for a process of detecting potential attacks using bounding box comparisons, according to aspects of the present disclosure.

FIG. 8 illustrates a decision process for detecting misbehavior in a vehicular communication system, according to an embodiment.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

The present disclosure may provide a system and method for detecting and verifying misbehavior in a vehicular network, particularly in a Cellular Vehicle-to-Everything (C-V2X) environment. The system may include a vehicular network and a misbehavior authority that communicates with vehicles within the network. The misbehavior authority may be configured to receive misbehavior reports from vehicles in the network, which are generated based on discrepancies between received collective perception messages (CPMs) and the vehicles' sensor data.

The misbehavior authority may also receive sensor data from the vehicles in the network and uses this data to generate an environment map. This map may then be used to analyze the misbehavior reports by comparing the information in the reports with the generated environment map. If the misbehavior report is verified, the misbehavior authority may initiate a certificate revocation process for the malicious vehicle.

The sensor data received from the vehicles in the network may include, but is not limited to, radio frequency (RF) signals, video data, radar data, and intra-sensor communication signals. The environment map may be generated using a deep learning-based tomography technique to process the sensor data received from the vehicles in the network.

The analysis of the misbehavior report may involve creating bounding boxes based on the generated environment map and the information in the misbehavior report and calculating an Intersection over Union (IoU) metric between the bounding boxes. Alternatively, the analysis may involve reconstructing the CPM based on the generated environment map, comparing the reconstructed CPM with the CPM received from the vehicle reporting misbehavior, and determining if an attack has occurred based on the comparison.

In some cases, the misbehavior authority may broadcast an updated CPM message to other vehicles in the vehicular network after initiating the certificate revocation process. The misbehavior authority may be integrated within a 5G core network, and the certificate revocation process may involve sending a revoke request to a Session Management Function (SMF) in the 5G core network.

In a real-world implementation of the disclosed solution, consider a busy urban intersection in a smart city equipped with a C-V2X network. This intersection may be prone to traffic congestion and potential safety hazards, making it an ideal location for deploying advanced vehicular communication and misbehavior detection systems.

In this scenario, multiple vehicles equipped with various sensors and V2X communication modules may approach the intersection. These vehicles may continuously exchange CPMs with each other and with roadside units. The CPMs may contain information about the vehicles'positions, speeds, and detected objects in their vicinity. Additionally, roadside sensors installed at the intersection may contribute to the overall perception of the environment. As the vehicles navigate through the intersection, one particular vehicle may attempt to manipulate the system by broadcasting false information in its CPMs. For instance, this malicious vehicle may report its position as being in the middle of the intersection when it is actually approaching from a side street. This false information may potentially cause other vehicles to make incorrect decisions, such as unnecessarily stopping or swerving, which could lead to traffic disruptions or even accidents.

In response to this situation, the misbehavior detection system may spring into action. Other vehicles in the vicinity, upon receiving the suspicious CPM, may compare it with their own sensor data and detect a discrepancy. These “honest” vehicles may then generate misbehavior reports and send them to a misbehavior authority (MA) integrated within the local 5G core network. The MA may process these reports along with sensor data from multiple sources to generate a comprehensive environment map of the intersection. Using advanced techniques such as deep learning-based tomography, the MA may create a highly accurate representation of the current traffic situation. The MA may then analyze the misbehavior reports by comparing them with this generated environment map, potentially using methods like bounding box comparisons or CPM reconstruction.

If the MA verifies the misbehavior, it may initiate a certificate revocation process for the malicious vehicle. This process may involve sending a revoke request to the Session Management Function (SMF) in the 5G core network. Subsequently, the MA may broadcast an updated CPM to all vehicles in the vicinity, alerting them to disregard information from the revoked vehicle and providing corrected environmental data.

Details of the solution will now be described with respect to the figures.

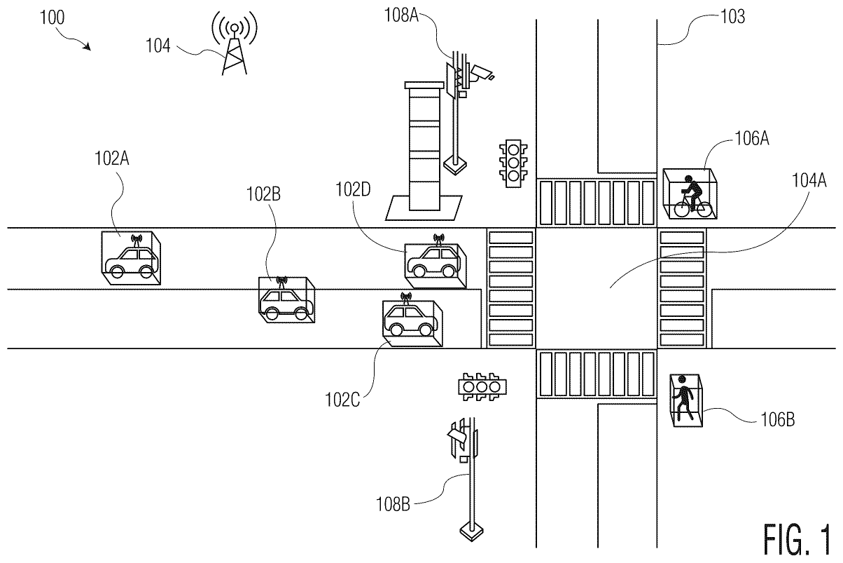

Referring now to FIG. 1, a system overview 100 of a vehicular communication network is illustrated. The system overview 100 shows multiple vehicles, such as vehicle 102A, vehicle 102B, vehicle 102C, and vehicle 102D within respective bounding boxes which are indicators of the perceived space in which the vehicles are located. Each vehicle may be equipped with various sensors, including but not limited to cameras, radars, and lidars. These sensors may be used to collect data about the vehicle's surroundings, including the positions and movements of other vehicles, pedestrians, and objects in the environment. The collected data may be used to generate a CPM, which is then transmitted to other vehicles and infrastructure within the vehicular network.

The system overview 100 may also include a communication tower 104, which may be positioned near a roadway 103. The communication tower 104 may facilitate wireless communication between the vehicles and other system components. In some cases, the communication tower 104 may include a base station for cellular network connectivity, enabling the transmission and reception of CPMs and other types of messages within the vehicular network.

In addition to the vehicles and the communication tower, the system overview 100 may include roadside sensor units, such as roadside sensor unit 108A and roadside sensor unit 108B. These units may be installed at strategic locations along the roadway, such as at the corners of the intersection 104A. The roadside sensor units may be equipped with various sensors, including cameras and other types of sensors, to monitor traffic and road conditions. The data collected by these units may be used to supplement the data collected by the vehicles' sensors, enhancing the overall perception of the environment within the vehicular network.

The system overview 100 may also account for non-automotive road users, including, for example, a bicyclist 106A and a pedestrian 106B within respective bounding boxes which are indicators of the perceived space in which the bicyclist and pedestrian are located. These road users may be detected and tracked by the various sensors in the system, and their positions and movements may be included in the CPMs generated by the vehicles and roadside sensor units.

In some aspects, the system overview 100 may include additional or alternative components, such as additional vehicles, additional roadside sensor units, or other types of infrastructure. For example, the system may include traffic lights, traffic signs, or other types of road markers. These components may also be equipped with sensors and communication capabilities, enabling them to participate in the vehicular network and contribute to the generation and transmission of CPMs.

In some cases, the system overview 100 may be implemented in different types of environments, such as urban areas, suburban areas, highways, or rural areas. The specific configuration and layout of the system components may vary depending on the characteristics of the environment. For example, in an urban area with dense traffic and complex road layouts, the system may include a larger number of vehicles and roadside sensor units to ensure comprehensive coverage of the environment. Conversely, in a rural area with sparse traffic and simple road layouts, the system may include fewer vehicles and roadside sensor units.

In some aspects, the system overview 100 may be integrated with other systems or networks, such as a city-wide traffic management system, a public transportation system, or a smart city infrastructure. This integration may enable the system to leverage additional data sources and capabilities, enhancing its ability to detect and respond to misbehavior in the vehicular network. For example, the system may use data from traffic cameras, weather sensors, or other types of sensors installed throughout the city to supplement the data collected by the vehicles and roadside sensor units. This additional data may improve the accuracy and reliability of the environment map generated by the misbehavior authority, thereby enhancing the system's ability to detect and verify misbehavior.

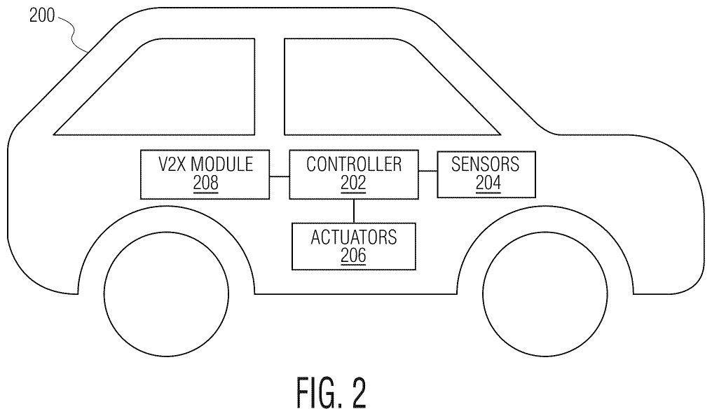

Referring to FIG. 2, an example vehicle 200 is illustrated with its internal components. The vehicle 200 may be any type of vehicle capable of participating in a vehicular network, such as a car, truck, bus, or other types of motorized vehicles. In some cases, the vehicle 200 may also be a non-motorized vehicle, such as a bicycle or a pedestrian device, equipped with sensors and communication capabilities.

Inside the vehicle 200, several components are represented as labeled boxes. These components may include a controller 202, sensors 204, actuators 206, and a Vehicle-to-Everything (V2X) module 208. Each of these components may play a role in the operation of the vehicle 200 and its participation in the vehicular network.

The controller 202 may be a computing device or a processing unit that manages various functions of the vehicle 200. In some aspects, the controller 202 may be responsible for processing sensor data, executing control algorithms, managing vehicle operations, and coordinating communication activities. The controller 202 may interface with the sensors 204, actuators 206, and V2X module 208 to facilitate these functions.

The sensors 204 may include various types of sensors installed on the vehicle 200 to collect data about the vehicle's surroundings. These sensors may include, but are not limited to, cameras, radars, lidars, ultrasonic sensors, and other types of sensors capable of detecting objects, vehicles, pedestrians, and other elements in the environment. The sensor data collected by the sensors 204 may be used to generate a CPM, which is then transmitted to other vehicles and infrastructure within the vehicular network.

The actuators 206 may include various devices that perform physical actions in response to commands from the controller 202. These actuators may include, but are not limited to, steering actuators, brake actuators, throttle actuators, and other types of actuators responsible for controlling the movement and operation of the vehicle 200.

The V2X module 208 may be a communication device that enables the vehicle 200 to participate in the vehicular network. The V2X module 208 may be responsible for transmitting and receiving messages, such as CPMs, to and from other vehicles and infrastructure within the network. In some cases, the V2X module 208 may also be responsible for performing various communication-related functions, such as signal processing, error correction, and data encryption.

In some aspects, the vehicle 200 may include additional or alternative components, depending on the specific requirements of the vehicular network and the capabilities of the vehicle. For example, the vehicle 200 may include additional sensors for collecting more detailed or specific types of data, additional actuators for performing more complex or precise actions, or additional communication devices for supporting different types of communication protocols or standards.

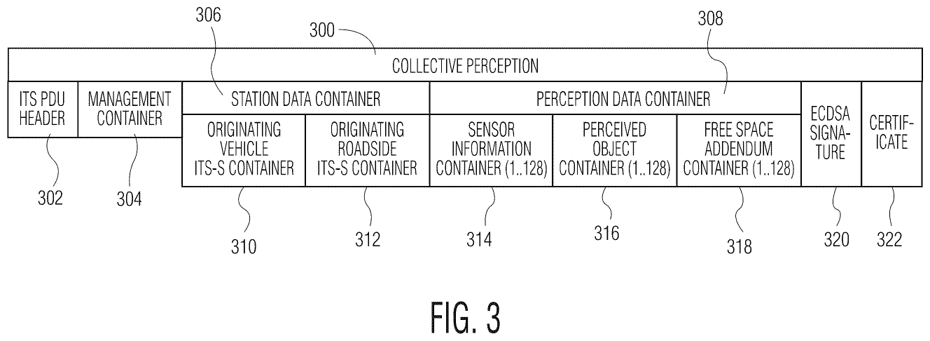

Referring to FIG. 3, a block diagram of a CPM structure 300 used in vehicular communication systems is illustrated. The CPM structure 300 may include a header and several data containers that organize and contain different types of information.

The CPM structure 300 may begin with an intelligent transportation system (ITS) protocol data unit (PDU) Header 302, which contains basic message information such as protocol version, message ID, and station ID. This header provides information for the identification and processing of the CPM in the vehicular network. The header information may include protocol versions, message type, and message segment information to name a few. CPM structure 300 may conclude with a signature 320 and a certificate 322.

Following the header is the Management Container 304, which includes details like ITS station (ITS-S) message type and reference position. This container provides high-level information about the CPM, such as the type of message it contains and the reference position from which the message was generated.

The Station Data Container 306 follows, containing information about the originating vehicle or roadside unit, such as vehicle orientation angle and trailer data. For roadside units, it may include intersection reference and map message details. This container provides specific information about the station that generated the CPM, which can be useful for understanding the context of the message and for verifying the authenticity of the message. Some information may include originating vehicle ITS-S container 310 which may include various pieces of information (e.g., vehicle orientation and trailer data,) and originating roadside ITS-S container 312 which may include various pieces of information (e.g., intersection reference/road segment ID and MAP message).

The Perception Data Container 308 forms another part of the CPM structure 300. This container is divided into several sub-containers: Sensor Information Container, Perceived Object Container, and Free Space Addendum Container. The Sensor Information Container includes details about the sensor type (vehicle sensor or stationary sensor) and sensor perception area. The Perceived Object Container holds information about detected objects, including their kinematic state and attributes. The Free Space Addendum Container provides data about free space, shadowing, and applicable areas. Some information may include sensor information container 314 which may include various pieces of information (e.g., sensor ID and sensor type), perceived object container 316 which may include various pieces of information (e.g., number of perceived objects, object ID, time of measurements, object kinematics and correlation matrix), and free space addendum container 318 which may include various pieces of information (e.g., free space ID, shadowing application and free space area).

It is noted that while not shown, CPM data structure 300 may also include information such as GenerationDeltaTime, CpmManagementContainer, and StationDataContainer among others.

The CPM structure 300 is designed to efficiently organize and transmit perception data between vehicles and infrastructure in a vehicular network, enabling shared awareness of the surrounding environment. In some aspects, the specific contents and format of the CPM structure 300 may vary depending on the requirements of the vehicular network and the capabilities of the vehicles and infrastructure. For example, additional containers may be included in the CPM structure 300 to accommodate additional types of data or information. Similarly, the specific fields within each container may be modified or extended to support different types of sensors, objects, or environmental conditions.

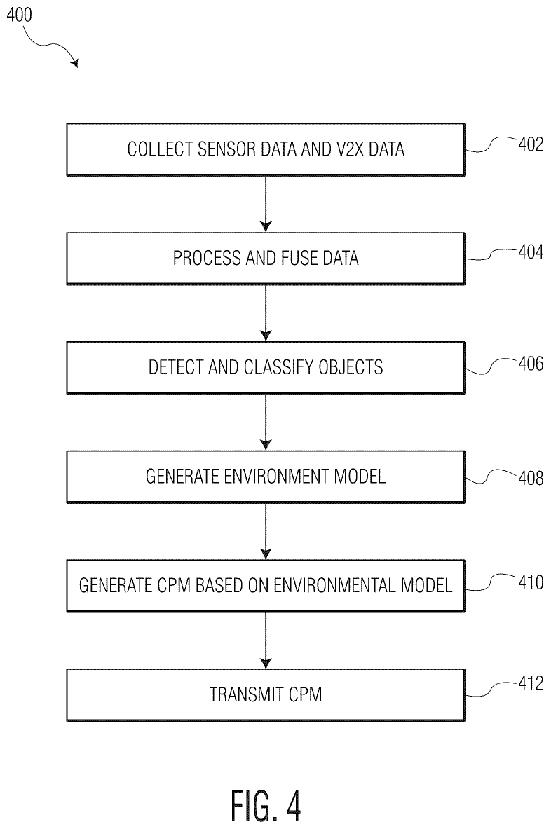

Referring to FIG. 4, a flowchart of a process 400 for generating and transmitting a CPM in a vehicular network is illustrated. The flowchart illustrates a process for creating and disseminating environmental perception information in a vehicular network context. This process encompasses the lifecycle of a CPM from data collection to transmission. It showcases how various data sources, including vehicle sensors and V2X communications, are integrated and processed to generate a detailed representation of the surrounding environment. The flowchart demonstrates the steps involved in transforming raw sensor data into actionable information that can be shared among vehicles and infrastructure components. This process may play a role in enhancing situational awareness, improving road safety, and enabling more efficient traffic management in connected vehicle ecosystems. The flowchart provides insight into the complex data processing and decision-making mechanisms underlying modern vehicular communication systems.

The process 400 begins with step 402, where sensor data and V2X data are collected. The sensor data may include, but is not limited to, data from cameras, radars, lidars, and other types of sensors installed on the vehicles. The V2X data may include, but is not limited to, data from vehicle-to-vehicle (V2V) communications, vehicle-to-infrastructure (V2I) communications, and vehicle-to-network (V2N) communications.

Following this, step 404 may involve processing and fusing the collected data via various data processing techniques, such as filtering, normalization, and data fusion. The data fusion may involve combining data from multiple sensors to create a comprehensive representation of the vehicle's surroundings.

In some cases, the data processing and fusion techniques employed in step 404 may include advanced algorithms such as Kalman filtering, particle filtering, or machine learning-based approaches. These techniques may help to reduce noise, handle uncertainties, and improve the overall accuracy of the fused data. Additionally, the process may incorporate temporal fusion, where data from different time steps are combined to create a more robust and consistent representation of the environment. This temporal aspect may be particularly beneficial for tracking moving objects and predicting their future positions, which is crucial for applications such as collision avoidance and path planning in dynamic environments.

The process 400 may then move to step 406, where objects are detected and classified based on the processed data. This step may involve various object detection and classification algorithms, such as machine learning algorithms, deep learning algorithms, or other types of algorithms. The detected objects may include other vehicles, pedestrians, obstacles, and other elements in the environment.

In some aspects, the object detection and classification algorithms used in step 406 may employ advanced techniques such as convolutional neural networks (CNNs), region-based convolutional neural networks (R-CNNs), or you only look once (YOLO) algorithms. These algorithms may be trained on large datasets of labeled images and sensor data to accurately identify and classify objects in real-time. The system may also utilize sensor fusion techniques to combine data from multiple sensors, such as cameras, lidars, and radars, to improve the accuracy and robustness of object detection and classification. This multi-modal approach may help overcome limitations of individual sensors, such as camera performance in low-light conditions or radar performance in detecting non-metallic objects. Additionally, the system may incorporate temporal tracking algorithms to maintain object identities across multiple frames, enabling the prediction of object trajectories and behaviors.

In step 408, an environment model may be generated using the detected and classified objects. This step may involve various environment modeling techniques, such as map-based modeling, grid-based modeling, or other types of modeling techniques. The environment model may represent the spatial distribution of the detected objects and their attributes, such as position, speed, and direction.

In some aspects, the environment model generated in step 408 may incorporate dynamic elements to account for the constantly changing nature of vehicular environments. This dynamic modeling may include techniques such as probabilistic occupancy grids, which represent the likelihood of object presence in different areas of the environment, or trajectory prediction models that estimate the future positions of moving objects. The environment model may also integrate contextual information, such as road layout, traffic rules, and weather conditions, to provide a more comprehensive understanding of the scene. Additionally, the model may employ multi-scale representations, allowing for both detailed local information and broader contextual awareness, which can be crucial for decision-making in complex traffic scenarios.

Step 410 involves generating a CPM based on the environmental model created in the previous step. The CPM may include various types of information, such as the vehicle's own status (position, speed, heading), information about detected objects, and information about the environment. The CPM may be formatted according to specific standards or protocols, such as the ITS PDU Header, Management Container, Station Data Container, and Perception Data Container as described in FIG. 3.

In step 412, the generated CPM is transmitted. The transmission may be performed over a specific communication channel, such as a V2X communication channel. The transmission may involve various communication protocols, such as Dedicated Short-Range Communications (DSRC), C-V2X, or other types of protocols.

In some aspects, the process 400 may include additional or alternative steps, depending on the specific requirements of the vehicular network and the capabilities of the vehicles. For example, the process may include additional steps for error checking, data encryption, or other types of operations. Similarly, the specific methods and techniques used in each step may vary depending on the specific implementation.

In a specific use case, consider a scenario where an autonomous vehicle is navigating through a busy urban intersection. As the vehicle approaches the intersection, it begins the process of generating and transmitting a CPM as outlined in FIG. 4.

In step 402, the vehicle's sensors 204, including cameras, radars, and lidars, may collect data about the surrounding environment. The cameras may capture visual information about traffic lights, road signs, and other vehicles. The radar sensors may detect the speed and distance of nearby objects, while the lidars create a detailed 3D map of the intersection. Simultaneously, the V2X module 208 receives data from nearby vehicles and infrastructure, such as the current state of traffic lights and the presence of emergency vehicles.

Moving to step 404, the controller 202 may process and fuse this collected data. It may apply noise reduction algorithms to the radar data, stitch together multiple camera feeds for a 360-degree view and align the lidar point cloud with the camera images. The V2X data is integrated with the sensor data to create a comprehensive representation of the intersection.

In step 406, the processed data may be used to detect and classify objects. The system may identify other vehicles, pedestrians crossing the street, cyclists in the bike lane, and stationary objects like traffic signs and light poles. Each object is classified and assigned attributes such as type, size, position, and velocity.

Step 408 may involve generating an environment model based on these detected and classified objects. The model may include a detailed layout of the intersection, the positions and trajectories of all moving objects, the state of traffic lights, and any potential hazards or obstacles.

In step 410, the vehicle may generate a CPM based on this environment model. The CPM includes the vehicle's own status (position, speed, heading), information about all detected objects, and relevant environmental data such as road conditions and traffic light states. This information may be structured according to the CPM format described in FIG. 3, with appropriate data populated in the ITS PDU Header, Management Container, Station Data Container, and Perception Data Container.

In step 412, the generated CPM may be transmitted via the V2X module 208. This transmission may use C-V2X protocols to communicate with nearby vehicles, infrastructure, and the central traffic management system. The transmitted CPM contributes to the collective awareness of all connected entities in the intersection, enhancing overall traffic safety and efficiency.

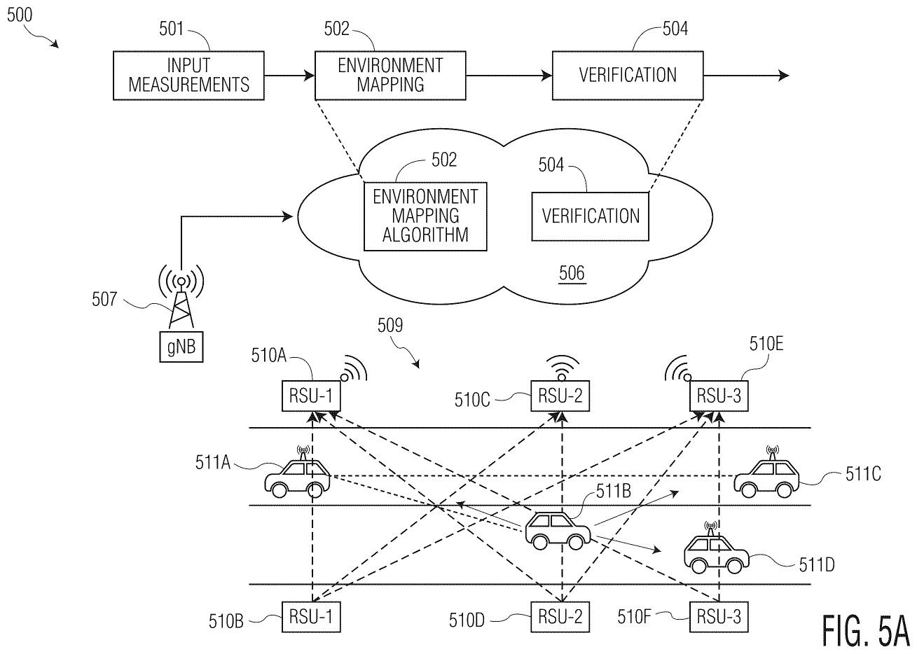

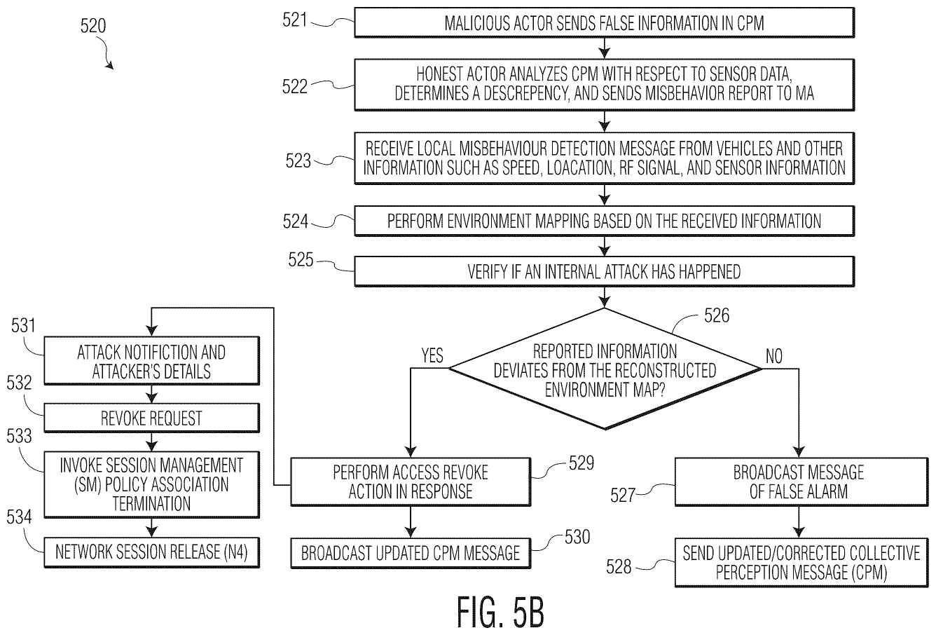

Referring to FIG. 5A, a system overview 500 of a vehicular communication and misbehavior detection system is illustrated. The system overview 500 includes input measurements 501, an environment mapping module 502, a verification module 504, a cloud server 506, a communication tower 507, and roadside sensor units 510A, 510B, 510C, 510D, 510E and 510F, communicating with vehicles 511A, 511B, 511C and 511D in the vehicular communication network 509.

The environment mapping module 502 may be configured to receive sensor data from various sources within the vehicular network as input measurements 501. These sources may include, but are not limited to, vehicles, roadside sensor units, and other types of infrastructure similar to those shown in FIG. 1. The sensor data may include various types of signals, such as radio frequency (RF) signals, video data, radar data, and intra-sensor communication signals. In some cases, the environment mapping module 502 may also receive data from other types of sensors or data sources, depending on the specific requirements of the vehicular network and the capabilities of the vehicles and infrastructure.

The environment mapping module 502 may process the received sensor data to generate an environment map. This map may represent a comprehensive and dynamic representation of the vehicular environment, including the positions, movements, and other relevant data of vehicles and infrastructure within a given area. The environment mapping module 502 may use various techniques and algorithms to generate the environment map, such as deep learning-based tomography, grid-based mapping, or other types of mapping techniques.

The verification module 504 may be configured to receive misbehavior reports from vehicles in the vehicular network. These reports may be generated based on discrepancies between the data reported by the vehicles and the data in the environment map. The verification module 504 analyzes the misbehavior reports by comparing the reported data with the environment map. If a discrepancy is detected, the verification module 504 may initiate a certificate revocation process for the malicious vehicle.

The cloud server 506 hosts the environment mapping algorithm and verification processes. It receives data from the communication tower 507 and the roadside sensor units 510A to 510F, processing this information to support the environment mapping and verification functions. The cloud server 506 may be configured to handle large volumes of data and perform complex computations, enabling it to support the real-time operation of the vehicular network.

The communication tower 507 facilitates cellular communication within the system. It transmits and receives signals and handles CPMs and Basic Safety Messages (BSMs). The communication tower 507 may be connected to a 5G core network, enabling high-speed, low-latency communication within the vehicular network.

The roadside sensor units 510A to 510F may be positioned along the roadway and are equipped with various sensors to monitor traffic and road conditions. These units may include cameras, radars, and other types of sensors. The data collected by these units may be used to supplement the data collected by the vehicles' sensors, enhancing the overall perception of the environment within the vehicular network.

In some aspects, the roadside sensor units 510A to 510F may be equipped with advanced processing capabilities, allowing them to perform local data analysis and filtering before transmitting information to the central system. This edge computing approach may help reduce network load and latency by processing raw sensor data at the source. The units may also incorporate machine learning algorithms to adapt to changing environmental conditions, such as varying traffic patterns or weather conditions, improving their detection accuracy over time. Additionally, these sensor units may be designed with redundancy and fail-safe mechanisms to ensure continuous operation even in the event of partial system failures, thereby maintaining a consistent flow of environmental data to the vehicular network.

In some aspects, the vehicular communication and misbehavior detection system illustrated by the system overview 500 may include additional or alternative components, depending on the specific requirements of the vehicular network and the capabilities of the vehicles and infrastructure. For example, the system may include additional roadside sensor units, or other types of infrastructure. These additional components may contribute to the generation of the environment map and the detection and verification of misbehavior in the vehicular network.

As previously mentioned, vehicles may communicate with one another and with roadside units using V2X technology, which includes V2V and V2I communication. This communication may be facilitated through various protocols such as Dedicated Short-Range Communications (DSRC) or C-V2X, utilizing the vehicles' V2X modules and the communication tower's cellular network. Vehicles may transmit and receive CPMs and BSMs, which contain information about their status, detected objects, and environmental conditions. These messages may be exchanged directly between vehicles using PC5 (Device-to-Device) links or through the cellular network. Roadside units may also participate in this communication, collecting and transmitting data about local traffic conditions and infrastructure status, thereby contributing to a comprehensive, real-time understanding of the vehicular environment.

Now that the system hardware and functionality have been described, the following section will delve into the detailed functionality of the Misbehavior Authority (MA). The MA plays a role in the vehicular network by detecting, verifying, and responding to potential misbehavior or malicious activities including specific processes and algorithms employed by the MA to analyze incoming data, generate environment maps, compare reported information with reconstructed data, and initiate appropriate responses to maintain the integrity and security of the vehicular communication system.

For example, FIG. 5B shows a flowchart for a process 520 of detecting and responding to misbehavior in a vehicular network is illustrated. The flowchart illustrates the process of identifying suspicious activities, verifying reported incidents, and taking appropriate actions to maintain the integrity and security of the network. The flowchart may depict the flow of information from the initial detection of anomalies to the final resolution, showcasing the interaction between various components of the system, such as vehicles, the Misbehavior Authority, and other network entities. The flowchart may offer insights into the decision-making processes and the sequence of events that occur when addressing potential threats in the vehicular communication system.

The process 520 begins with step 521, where a malicious actor sends false information in a CPM, or where a good intentioned actor sends false information due to a malfunction in the vehicle hardware (e.g. sensors, etc.) or software in a CPM. This false information may include, but is not limited to, incorrect position or speed data, manipulated sensor readings, or fabricated environmental conditions. The malicious actor may be a vehicle or a roadside unit within the vehicular network, and the false information may be intended to disrupt the operation of the network or to gain an unfair advantage.

In some cases, the malicious actor may employ sophisticated techniques to generate and transmit false information in the CPM. For example, the actor may use advanced spoofing methods to manipulate GPS signals, creating the illusion of a different vehicle position or trajectory. The malicious actor may also exploit vulnerabilities in the sensor fusion algorithms of other vehicles, injecting carefully crafted data that appears plausible but leads to incorrect environmental perceptions. Additionally, the bad actor may coordinate with other compromised vehicles or infrastructure elements to create a consistent but false representation of the environment, making the deception more difficult to detect. These advanced tactics may be employed to achieve various malicious goals, such as causing traffic congestion, forcing other vehicles to take suboptimal routes, or even creating dangerous situations that may lead to accidents.

In step 522, an honest actor, which may be another vehicle or roadside unit in the network, analyzes the received CPM with respect to its own sensor data. The honest actor may use various techniques to analyze the CPM, such as data comparison algorithms, anomaly detection methods, or machine learning models. The analysis may involve comparing the data in the CPM with the sensor data, checking for inconsistencies or discrepancies that may indicate misbehavior.

In determining the discrepancy, the honest actor may employ a multi-layered approach to enhance the accuracy and reliability of the detection process. This approach may involve comparing multiple data points and utilizing various analytical techniques. For instance, the honest actor may first cross-reference the received CPM data with its own sensor readings, looking for significant deviations in reported positions, velocities, or object classifications. Additionally, the honest actor may leverage historical data and predictive models to assess the plausibility of the received information. Machine learning algorithms may be employed to identify patterns or anomalies that might not be immediately apparent through simple data comparison. The honest actor may also consider contextual information, such as road layout, traffic rules, and typical behavior of vehicles in the given environment, to evaluate the likelihood of the reported data being accurate. In some cases, the honest actor may collaborate with nearby vehicles or infrastructure units, exchanging and corroborating information to build a more comprehensive understanding of the environment and increase the confidence level of the discrepancy detection. This multi-faceted approach helps to minimize false positives while improving the overall robustness of the misbehavior detection system.

If a discrepancy is detected, the honest actor may generate a misbehavior report and send it to a Misbehavior Authority (MA) in step 523. The misbehavior report may include various types of information, such as the details of the detected discrepancy, the identity of the malicious actor, the data in the received CPM, and the sensor data of the honest actor. The misbehavior report may be formatted according to specific standards or protocols and may be encrypted or digitally signed to ensure its integrity and authenticity.

Upon receiving the misbehavior report, the MA may perform environment mapping based on sensor data received from the vehicles in the vehicular network in step 524. The environment mapping may involve creating a digital representation of the vehicular environment, including the positions, movements, and other relevant data of vehicles and infrastructure within a given area. The environment mapping may be performed using various techniques, such as deep learning-based tomography, grid-based mapping, or other types of mapping techniques.

In some aspects, the environment mapping process may incorporate advanced data fusion techniques to integrate information from diverse sensor types and sources. This fusion may involve combining data from vehicle-mounted sensors, roadside units, and even satellite imagery to create a more comprehensive and accurate representation of the environment. The MA may employ sophisticated algorithms to handle the heterogeneity of data sources, accounting for differences in sensor accuracy, update rates, and coverage areas. Additionally, the environment mapping process may utilize temporal filtering techniques to smooth out inconsistencies and predict short-term future states of the environment. This predictive capability may enhance the system's ability to detect anomalies by comparing received CPMs not only with the current environmental state but also with projected future states. The resulting environment map may be a multi-layered, dynamic representation that includes not only physical objects and their attributes but also semantic information about road conditions, traffic patterns, and potential hazards.

In step 525, the MA analyzes the misbehavior report by comparing the information in the report with the generated environment map. The analysis may involve various techniques, such as data comparison algorithms, anomaly detection methods, or machine learning models. The analysis may involve checking for inconsistencies or discrepancies between the reported data and the environment map, which may indicate misbehavior.

In some cases, the MA may employ advanced statistical techniques and probabilistic models to assess the likelihood of misbehavior. For instance, the MA may use Bayesian inference to update its belief about the trustworthiness of the reporting vehicle based on historical data and current observations. The MA may also utilize ensemble methods, combining multiple analysis techniques to improve the accuracy and robustness of misbehavior detection. Additionally, the MA may consider the reputation and trust scores of the reporting vehicles, giving more weight to reports from vehicles with consistently reliable reporting histories. The analysis may also take into account the spatial and temporal context of the reported information, considering factors such as traffic patterns, road conditions, and recent events that might influence the plausibility of the reported data.

Following the analysis, the process 520 proceeds to a decision point at step 526, where the MA determines if the reported information deviates from the reconstructed environment map. If the reported information deviates from the environment map (YES branch), the process 520 proceeds to step 529, where the MA initiates an access revoke action for the malicious actor. The access revoke action may involve various steps, such as sending a revoke request to a Session Management Function (SMF) in a 5G core network, broadcasting a revocation notice to other vehicles and infrastructure in the network, or updating the environment map to reflect the revocation.

Following the access revoke action in step 529, the process 520 moves to step 530, where the MA broadcasts an updated CPM message to other vehicles in the vehicular network. The updated CPM message may include various types of information, such as the details of the analyzed misbehavior report, the results of the analysis, or instructions for the vehicles and infrastructure to disregard the misbehavior report. The updated CPM message may also include information about the revoked vehicle, such as its identity, last known position, or other relevant data.

In some aspects, the MA may use different methods or protocols to broadcast the updated CPM message. For example, the MA may broadcast the message over a specific communication channel, such as a V2X communication channel, or it may use a broadcast protocol that is compatible with the vehicles and infrastructure in the network. The MA may also encrypt or digitally sign the updated CPM message to ensure its integrity and authenticity.

Following the access revoke action in step 529, the process 520 may also include additional steps to ensure comprehensive handling of the detected misbehavior. These steps may include:

In step 531, the MA may perform attack notification and provide attacker's details. This step may involve notifying relevant network entities about the detected attack and sharing pertinent information about the malicious actor. The notification may include details such as the attacker's identity, the nature of the attack, and any observed patterns of malicious behavior. This information may help other network participants to be more vigilant and potentially recognize similar attack patterns in the future.

In some cases, the attack notification process may also involve a multi-tiered alerting system based on the severity and potential impact of the detected attack. The MA may categorize the attack into different threat levels, each triggering a specific response protocol. For high-severity attacks, the notification may be broadcast immediately to all network participants, including vehicles, infrastructure units, and traffic management centers. For lower-severity attacks, the notification may be distributed more selectively to relevant entities or geographical areas. The MA may also include recommendations for preventive measures or temporary adjustments to security protocols in the notification, enabling the network to adapt dynamically to emerging threats. Additionally, the system may implement a feedback mechanism, allowing recipients of the attack notification to report any related observations or additional information, further enhancing the collective intelligence of the network in combating malicious activities.

Step 532 may involve sending a revoke request. In this step, the MA may formally initiate the process of revoking the malicious actor's access to the network. This request may be sent to appropriate network management entities, such as the Session Management Function (SMF) in a 5G core network. The revoke request may contain information to identify the malicious actor and justify the revocation action.

In some aspects, the revoke request may include additional security measures to ensure its authenticity and prevent potential interception or tampering. For instance, the MA may employ advanced encryption techniques or digital signatures specific to the vehicular network environment. The request may also contain a time-stamped log of the detected misbehavior, including relevant sensor data and environmental context, to provide comprehensive evidence supporting the revocation action. Furthermore, the MA may implement a multi-stage verification process for the revoke request, requiring acknowledgment from multiple trusted network entities before the revocation is fully executed. This approach may help prevent false revocations and maintain the overall integrity of the network's security protocols.

In step 533, the process may invoke Session Management (SM) policy association termination. This step may involve terminating any active network sessions associated with the malicious actor. The SM policy association termination may ensure that the attacker can no longer participate in the network using their current credentials or session information. This step may be crucial in preventing further malicious activities from the compromised entity.

In some aspects, the SM policy association termination may involve a multi-layered approach to ensure comprehensive session closure. This may include terminating not only the primary session but also any subsidiary or related sessions that the malicious actor might have established. The MA may coordinate with various network components, such as the Access and Mobility Management Function (AMF) and the Policy Control Function (PCF), to ensure that all policy-related associations are properly terminated across the network. Additionally, the system may implement a temporary blacklist mechanism, preventing the malicious actor from immediately re-establishing new sessions or policy associations. This blacklist may be shared across the network to maintain a consistent security posture and prevent the attacker from exploiting potential gaps in different network segments.

Step 534 may involve network session release, specifically referencing the N4 interface in a 5G network architecture. This step may entail releasing all network resources allocated to the malicious actor's session. The N4 interface, which typically connects the Session Management Function (SMF) to the User Plane Function (UPF), may be utilized to facilitate this release of resources. This step ensures that the network efficiently reclaims any bandwidth, processing power, or other resources that were allocated to the now-revoked session.

In some cases, the network session release process may involve additional coordination with other network functions to ensure a comprehensive cleanup of the malicious actor's presence in the system. For instance, the SMF may communicate with the Policy Control Function (PCF) to update any policy rules associated with the revoked session. The SMF may also interact with the Network Exposure Function (NEF) to notify any third-party applications or services that may have been accessing the network through the revoked session. Furthermore, the process may include updating relevant databases and logs to maintain an accurate record of the session termination, which can be crucial for future audits, security analysis, and potential legal proceedings. This comprehensive approach to network session release helps to maintain the integrity and security of the 5G network infrastructure in the context of vehicular communications.

In some aspects, the access revoke action may also involve additional security measures to ensure the comprehensive removal of the malicious actor from the network. For instance, the MA may initiate a blockchain-based revocation process, where the revocation information is distributed and verified across multiple nodes in the network, ensuring tamper-proof and transparent record-keeping. The MA may also trigger a temporary increase in the security threshold for nearby vehicles, prompting them to perform more rigorous authentication checks on incoming messages. Furthermore, the system may employ machine learning algorithms to analyze the behavior patterns of the revoked actor, using this information to enhance future threat detection capabilities and potentially identify other compromised entities within the network.

In some cases, the MA may use different methods or protocols to initiate the access revoke action. For instance, the MA may send the revoke request directly to the malicious vehicle, or it may send the request to a network management entity that has the authority to revoke the vehicle's access. The MA may also use different communication channels or protocols to broadcast the revocation notice, depending on the specific requirements of the vehicular network and the capabilities of the vehicles and infrastructure.

In some aspects, the MA may implement a tiered approach to access revocation, depending on the severity and certainty of the detected misbehavior. For less severe or less certain cases, the MA may initially issue a warning or temporary suspension to the suspected malicious vehicle, allowing for further investigation or self-correction. In more severe cases, the MA may employ a gradual revocation process, first limiting the vehicle's access to certain network functions or reducing its trust score within the network before proceeding to full revocation. The MA may also coordinate with other network entities, such as roadside units or nearby vehicles, to corroborate the misbehavior detection and ensure a more robust and distributed revocation process. Additionally, the MA may implement failsafe mechanisms to prevent potential misuse of the revocation system itself, such as requiring multiple independent verifications before executing a full access revoke action.

If, however, the reported information does not deviate from the environment map (NO branch), the process 520 proceeds to step 527, where the MA broadcasts a false alarm message to the vehicles and infrastructure in the network and step 528 where the MA sends an updated CPM. The false alarm message may include various types of information, such as the details of the analyzed misbehavior report, the results of the analysis, or instructions for the vehicles and infrastructure to disregard the misbehavior report.

This step of broadcasting a false alarm message and updated CPM helps maintain the integrity and efficiency of the vehicular network. By promptly informing all network participants about the false nature of a reported misbehavior, the system prevents unnecessary actions or responses that may disrupt normal operations. This communication helps to maintain trust in the network by demonstrating transparency and the system's ability to accurately verify and respond to potential threats. Moreover, it serves as a learning opportunity for the network, allowing vehicles and infrastructure to refine their detection algorithms and reduce the likelihood of future false positives. The false alarm message also contributes to the overall resilience of the system by ensuring that resources are not wasted on non-existent threats and that the network can quickly return to its normal state of operation.

In some aspects, the process 520 may include additional or alternative steps, depending on the specific requirements of the vehicular network and the capabilities of the MA. For example, the process may include additional steps for error checking, data encryption, or other types of operations. Similarly, the specific methods and techniques used in each step may vary depending on the specific implementation.

In some aspects, these steps may be executed in parallel or in a different order, depending on the specific implementation of the network architecture and the urgency of the situation. The MA may also implement additional verification steps or fail-safes between these actions to ensure the integrity of the revocation process.

In a specific use case, consider a scenario where an autonomous vehicle is navigating through a busy urban intersection. As the vehicle approaches the intersection, it receives a CPM from another vehicle claiming to be at the center of the intersection. However, this information conflicts with the autonomous vehicle's own sensor data, which shows the intersection is clear.

The autonomous vehicle's system, acting as the honest actor in step 522, analyzes the received CPM against its own sensor data. It detects a significant discrepancy between the reported position of the other vehicle and its own perception of the environment. In response, the autonomous vehicle generates a misbehavior report and sends it to the Misbehavior Authority (MA) as described in step 523.

Upon receiving this report, the MA initiates the process of environment mapping (step 524) by collecting sensor data from multiple sources, including other vehicles in the vicinity, roadside units, and traffic cameras. This comprehensive data collection allows the MA to create an accurate representation of the current state of the intersection.

In step 525, the MA verifies the reported misbehavior by comparing the environment map with the information provided in the misbehavior report. The verification process confirms that there is indeed no vehicle at the center of the intersection, as claimed in the suspicious CPM. This leads to the decision point in step 526, where the MA determines that the reported information significantly deviates from the reconstructed environment map.

As a result, the MA initiates the access revoke action (step 529) for the vehicle that sent the false CPM. This action may involve sending a revoke request to the Session Management Function in the 5G core network, effectively cutting off the malicious vehicle's access to the V2X communication system. Simultaneously, the MA broadcasts an updated CPM (step 530) to all vehicles in the vicinity, alerting them to disregard the false information and providing the correct status of the intersection.

This use case demonstrates how the misbehavior detection and verification process can effectively identify and mitigate potential safety risks in a complex urban traffic scenario, ensuring the integrity of the V2X communication system and the safety of all road users.

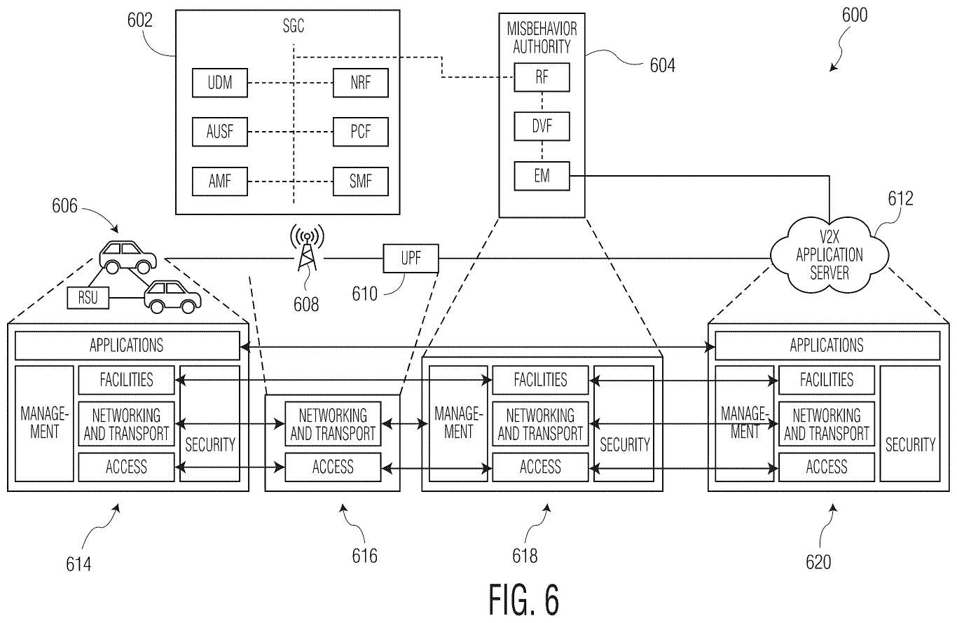

Referring to FIG. 6, a block diagram of network architecture layers 600 for a vehicular communication system is illustrated. The network architecture layers 600 include several interconnected components that facilitate communication and misbehavior detection in a vehicular network.

The diagram shows an SGC module 602, which represents the 5G Core network components. This module includes various functions such as Unified Data Management (UDM), Authentication Server Function (AUSF), Access & Mobility Management Function (AMF), Network Repository Function (NRF), Policy Control Function (PCF) and Session Management Function (SMF). These functions are responsible for managing user data, authenticating users, and managing access and mobility within the network, respectively.

In some examples, UDM may handle user authentication, authorization, and subscription management, storing and managing user profile data. AUSF may provide authentication services for users and devices, working with the UDM to verify identities and credentials. AMF may manage user access and mobility, handling tasks such as registration, connection, and handover between different network nodes. NRF may maintain a repository of available network services and functions, enabling service discovery and selection within the network. PCF may define and enforce network policies, managing quality of service, charging rules, and access control policies. SMF may handle session establishment, modification, and termination, managing IP address allocation and data flows for user equipment.

Misbehabvior Authority (MA) 604 is also depicted, which contains a Radio Frequency (RF) component, Detection & Verification Function (DVF), and Environment Mapping (EM) components. MA 604 may be responsible for detecting and verifying misbehavior in the network. The RF component handles radio frequency communications, the DVF component detects and verifies potential misbehavior, and the EM component generates an environment map based on sensor data from the vehicles in the network.

In some aspects, these functions may work together to enable efficient network operation, policy enforcement, and session management in 5G vehicular communication systems. The integration of these functions within the SGC module 602 may allow for seamless coordination of network resources and policies in support of vehicular applications and services.

The vehicles and roadside units 606 are shown at the bottom left of the diagram. These units communicate with the network through a communication tower 608, which is connected to a UPF 610 which may be responsible for managing user plane traffic in the network, including the transmission and reception of CPMs and other types of messages.

A V2X Application Server 612 is illustrated on the right side of the diagram, which interacts with other components of the system. The V2X Application Server 612 may host various applications and services related to vehicular communication, such as traffic management, safety applications, and infotainment services.

The diagram also depicts the architecture layers for different components including layers 614, 616, 618 and 620 described below.

Vehicle and roadside unit architecture 614: This architecture may include various layers such as Applications, Facilities, Networking and Transport, and Access layers. These layers handle different aspects of the vehicle's operation, including application services, data processing, network communication, and physical access to the network.

Communication tower and UPF architecture 616: This architecture may include various similar layers as the vehicle and roadside unit architecture but is focused on the operation of the communication tower. These components handle the transmission and reception of messages in the network, as well as the management of user plane traffic.

MA architecture 618: This architecture may comprise several layers that work together to enable efficient misbehavior detection and verification in the vehicular network. The application layer may host the core misbehavior detection algorithms and decision-making processes. The facilities layer may provide support services such as data fusion, message formatting, and security functions. The networking and transport layer may handle communication protocols specific to misbehavior reporting and verification. The access layer may manage connections with various network entities, including vehicles and infrastructure components. Additionally, the MA architecture may include a management layer for coordinating operations across all layers and a security layer for implementing robust protection mechanisms against potential attacks on the MA itself.

V2X application server architecture 620: This architecture may include layers similar to the other architectures but is focused on the operation of the V2X Application Server. The V2X Application Server hosts various applications and services related to vehicular communication.

In some aspects, the vehicle and roadside unit architecture 614 may operate across multiple layers in the system. The applications layer may collect and process sensor data, generating local misbehavior reports. The facilities layer may perform session management, presentation, and network services for the application layer. The networking and transport layer may transmit CPMs and misbehavior reports. The access layer may manage V2X communication channels. Management and security functions may span across the facilities, networking and transport, and access layers. The security layer may apply encryption and digital signatures for data integrity.

In some cases, the communication tower may function as a wireless access point. At the networking and transport layer, these components may route messages between vehicles and the MA. At the access layer, they may manage connections with vehicles and the MA.

The MA architecture 618 may operate across several layers. The facilities layer may perform session management, presentation, and network services for the application layer. The networking and transport layer may facilitate communication with vehicles and the 5G core. The access layer may manage network component connections. Management and security functions may span across the facilities, networking and transport, and access layers.

In some aspects, the V2X application server architecture 620 may function at multiple layers. The applications layer may run the overall misbehavior authority application. The facilities layer may perform session management, presentation, and network services for the application layer. The networking and transport layer may exchange data with the MA and 5G core. The access layer may manage server connections. The management layer may oversee system-wide operations, while the security layer may maintain security policies and certificates.

These multi-layered architectures may enable comprehensive and efficient operation of the vehicular communication system, facilitating misbehavior detection, data exchange, and overall network management across various components and functions.

It is noted that blocks 610, 614, 616, 618 and 620 are logical blocks representing different processing layers within the vehicular communication system. These architectures may be implemented as software modules, virtual network functions, or distributed across various physical hardware components. By organizing the system into these logical blocks, the network can flexibly allocate resources, scale functionality, and manage complex operations across different aspects of vehicular communication and misbehavior detection.

In some aspects, the network architecture layers 600 may include additional or alternative components, depending on the specific requirements of the vehicular network and the capabilities of the vehicles and infrastructure. For example, the network may include additional network components, such as additional base stations or roadside units, to enhance the coverage and capacity of the network. Similarly, the network may include additional functions or services in the SGC module 602 or the V2X Application Server 612, to support additional applications or use cases in the vehicular network.

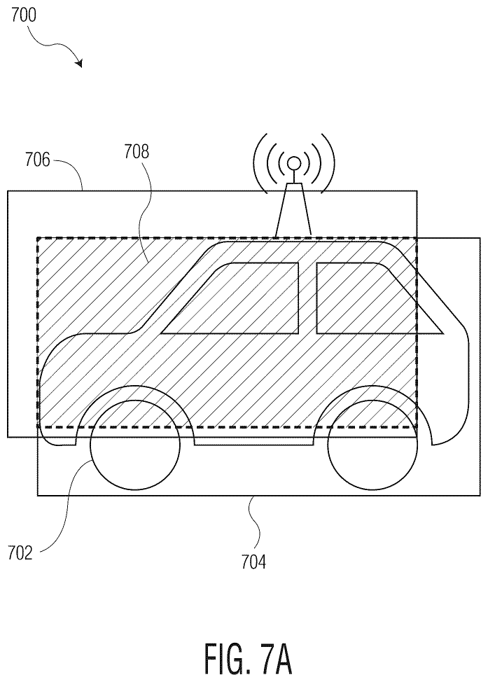

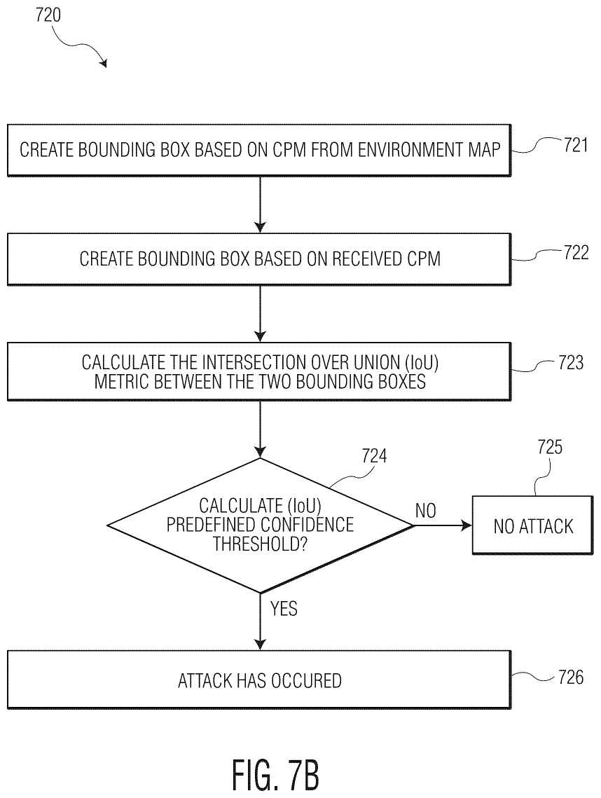

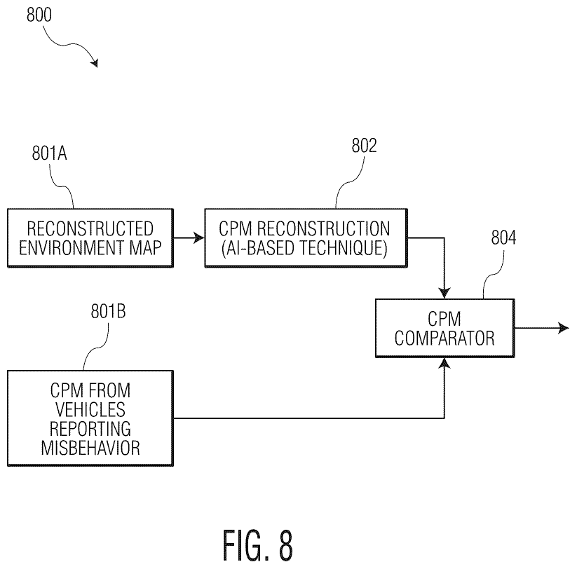

FIGS. 7A, 7B, and 8 will be described as example algorithms for verifying misbehavior in the vehicular network. These figures illustrate specific approaches to detecting and analyzing potential discrepancies between reported and observed vehicle data. It should be noted that while these algorithms provide effective methods for misbehavior verification, they are not exhaustive, and other algorithms or variations may be employed depending on the specific requirements, environmental conditions, or technological capabilities of the vehicular communication system.

Referring to FIG. 7A, a bounding box illustration 700 for a vehicle detection system is depicted. The bounding box illustration 700 includes a vehicle 702, a ground truth bounding box 704, and a perceived bounding box 706. The ground truth bounding box 704 may represent the actual position and dimensions of the vehicle as determined from a CPM derived from an environment map. The perceived bounding box 706 may represent the detected position and dimensions of the vehicle based on a received CPM.

The ground truth bounding box 704 may be created using information from the CPM derived from the environment map, which may include precise location data, vehicle dimensions, and orientation. This data may be processed to construct a representation of the vehicle's position and size in the environment. The perceived bounding box 706 may be generated based on the received CPM, which may contain information about the vehicle as perceived by other vehicles or infrastructure in the network. The system may then compare these two bounding boxes by calculating a metric such as an Intersection over Union (IoU) metric, which quantifies the overlap 708 between the ground truth bounding box 704 and the perceived bounding box 706. This comparison may allow for the assessment of potential discrepancies between the environment map-derived data and the received CPM data, which may be used in the misbehavior detection process.

In some aspects, the bounding box illustration 700 may be used to detect and verify misbehavior in a vehicular network. For instance, if a vehicle reports a position or dimensions that do not match the ground truth bounding box 704, this discrepancy may be detected as potential misbehavior. The perceived bounding box 706, which is based on sensor data, may be used to independently verify the reported position and dimensions of the vehicle. If the perceived bounding box 706 does not match the ground truth bounding box 704, this discrepancy may be further evidence of misbehavior.

The bounding box illustration 700 demonstrates the concept of the IoU metric, which may be used to compare the overlap 708 between the ground truth bounding box 704 and the perceived bounding box 706. The IoU metric is a measure of the overlap 708 between two bounding boxes, calculated as the area of intersection divided by the area of union. In the context of misbehavior detection, the IoU metric may be used to quantify the discrepancy between the reported position and dimensions of a vehicle and the actual position, and dimensions as determined from sensor data.

In some cases, the IoU metric may be used in conjunction with other parameters to enhance the accuracy of misbehavior detection. For example, the system may consider the temporal consistency of IoU values over multiple frames, the relative velocities of vehicles, and the confidence scores of object detection algorithms. Additionally, the IoU threshold for determining misbehavior may be dynamically adjusted based on factors such as traffic density, weather conditions, or the type of environment (urban, highway, etc.). This adaptive approach may help to reduce false positives in challenging scenarios while maintaining a high level of sensitivity to potential misbehavior. Furthermore, the system may employ machine learning techniques to analyze patterns in IoU discrepancies over time, potentially identifying more subtle forms of misbehavior or systematic errors in vehicle reporting.

In some cases, the bounding box illustration 700 may be used in conjunction with other techniques or methods for misbehavior detection. For example, the bounding box illustration 700 may be used in combination with machine learning algorithms, anomaly detection methods, or other types of data analysis techniques. These additional techniques or methods may provide additional insights or capabilities for detecting and verifying misbehavior in a vehicular network.

In some aspects, the bounding box illustration 700 may be adapted or modified to accommodate different types of vehicles, sensors, or environments. For example, the bounding boxes may be adjusted to account for different vehicle sizes, shapes, or orientations. The bounding boxes may also be adjusted to account for different sensor capabilities, such as different sensor ranges, resolutions, or accuracies. Furthermore, the bounding boxes may be adjusted to account for different environmental conditions, such as different road layouts, traffic conditions, or weather conditions. These adaptations or modifications may enhance the accuracy and robustness of the bounding box illustration 700 for misbehavior detection.

In some aspects, the bounding box illustration 700 may utilize either two-dimensional (2D) or three-dimensional (3D) representations, depending on the specific requirements and capabilities of the vehicular detection system. A 2D bounding box may be sufficient for scenarios where vehicles are primarily detected and tracked on a planar surface, such as a typical road environment. However, in more complex scenarios involving multi-level intersections, overpasses, or hilly terrain, a 3D bounding box may provide a more accurate representation of the vehicle's position and dimensions. The choice between 2D and 3D bounding boxes may depend on factors such as the available sensor data, computational resources, and the level of detail for effective misbehavior detection in the given environment.

Referring to FIG. 7B, a flowchart for a process 720 of detecting potential attacks using bounding box comparisons is illustrated.

In step 721, a bounding box is created based on a CPM derived from an environment map. This step may involve processing the environmental data contained in the CPM to generate a spatial representation of the reported vehicle position and dimensions. In some aspects, the creation of this bounding box may involve advanced data fusion techniques to integrate information from multiple sources within the environment map. The system may employ machine learning algorithms, such as convolutional neural networks or random forests, to process and interpret the environmental data more accurately. Additionally, the bounding box creation process may incorporate temporal information, considering not just the current state but also the recent history of the vehicle's reported position and dimensions to create a more robust representation.

Step 722 may involve creating another bounding box based on a received CPM. This bounding box may represent the vehicle's position and dimensions as reported by the vehicle itself or as perceived by other vehicles or infrastructure in the network. In some cases, the creation of this bounding box may involve a multi-stage verification process. The system may cross-reference the received CPM data with information from nearby vehicles or infrastructure to enhance the accuracy of the bounding box. Furthermore, the process may employ probabilistic methods to account for potential uncertainties in the reported data, resulting in a bounding box that represents not just a single point estimate but a probability distribution of the vehicle's likely position and dimensions.

In step 723, the process calculates the IoU metric between the two bounding boxes created in steps 721 and 722. The IoU metric may quantify the degree of overlap between the two spatial representations, providing a measure of consistency between the reported and perceived vehicle data. In some aspects, the IoU calculation may be extended to incorporate additional dimensions beyond spatial overlap. For instance, the system may consider the similarity of velocity vectors, acceleration profiles, or even predicted future positions. This multi-dimensional IoU metric may provide a more comprehensive measure of consistency between the reported and perceived vehicle data, potentially improving the accuracy of misbehavior detection.

Step 724 represents a decision point where the calculated IoU may be compared against a predefined confidence threshold. This threshold may be set based on various factors such as the expected accuracy of the sensors, environmental conditions, or historical data on typical discrepancies. In some cases, the confidence threshold may be dynamically adjusted based on real-time conditions. The system may employ adaptive algorithms that consider factors such as traffic density, weather conditions, or the reliability history of specific vehicles or infrastructure components. This dynamic thresholding approach may enhance the system's ability to balance between sensitivity to potential attacks and resilience against false positives in varying operational contexts.

If the calculated IoU is greater than the predefined confidence threshold, the process follows the YES branch to step 726, indicating that an attack has been detected. This may suggest a significant discrepancy between the reported and perceived vehicle data, potentially indicating malicious activity or a severe malfunction. In some aspects, the system may implement a multi-level response strategy when an attack is detected. This may include immediate local actions such as temporarily ignoring data from the suspected malicious vehicle, as well as broader network-wide responses such as alerting nearby vehicles and infrastructure components. The system may also initiate a more detailed analysis of the detected discrepancy, potentially employing additional verification methods or consulting historical data to further characterize the nature and severity of the potential attack.

If the calculated IoU is not greater than the predefined confidence threshold, the process follows the NO branch to step 725, indicating that no attack has been detected. This may suggest that the reported and perceived vehicle data are sufficiently consistent, within the acceptable margin of error defined by the threshold. In some cases, even when no attack is detected, the system may still log and analyze the comparison results. This ongoing analysis may help refine the detection algorithms over time, potentially identifying subtle patterns or trends that may indicate more sophisticated or evolving attack strategies. Additionally, the system may use these “normal” instances to continuously update its understanding of typical vehicle behavior, allowing for more accurate and context-aware misbehavior detection in the future.

In some aspects, the process 720 may incorporate additional steps or decision points to refine the attack detection mechanism. For example, the system may consider multiple consecutive IoU calculations over time to reduce false positives, or it may adjust the confidence threshold dynamically based on current traffic conditions or sensor reliability metrics.

In a specific use case, consider a scenario where an autonomous vehicle is navigating through a busy urban intersection. As the vehicle approaches the intersection, it receives a CPM from another vehicle claiming to be at the center of the intersection. However, this information conflicts with the autonomous vehicle's own sensor data, which shows the intersection is clear.

The MA may initiate the process 720 to verify the received information. In step 721, the MA may create a bounding box based on the environmental map derived from aggregated sensor data and other trusted sources from multiple vehicles and infrastructure components. This bounding box may represent the MA's understanding of the current state of the intersection, including the positions of detected vehicles and objects.

In step 722, the MA may create another bounding box based on the received CPM from the suspicious vehicle. This bounding box may represent the claimed position and dimensions of the vehicle at the center of the intersection as reported in the CPM.

The MA may then proceed to step 723, where it calculates the IoU metric between these two bounding boxes. In this case, the IoU may be low or even zero, as the bounding box from the MA's comprehensive environmental map (e.g., showing an empty intersection) may have little to no overlap with the bounding box created from the received CPM (e.g. showing a vehicle in the center of the intersection).

At the decision point in step 724, the MA may compare this calculated IoU against a predefined confidence threshold. Given the discrepancy between the two bounding boxes, the IoU may likely be below the threshold. Consequently, the process may follow the YES branch to step 726, indicating that a potential attack or severe malfunction has been detected.

In some aspects, the MA may utilize additional data sources and verification methods to corroborate the detection of potential misbehavior. For instance, the MA may cross-reference the bounding box comparison results with historical traffic patterns, real-time video feeds from nearby infrastructure cameras, or data from other vehicles in the vicinity. This multi-faceted approach may enhance the reliability of the misbehavior detection process and reduce the likelihood of false positives.

This use case demonstrates how the process 720 can effectively identify potential misbehavior or false information in a vehicular network, contributing to the overall safety and reliability of autonomous vehicle operations in complex urban environments.

In addition to the bounding box comparison method described earlier, the system may employ another method for detecting an attack in the vehicular network. This alternative approach, illustrated in FIG. 8, presents a decision process 800 that utilizes CPM reconstruction and comparison techniques to identify potential misbehavior.

The decision process 800 comprises two main components: a CPM reconstruction step 802 and a CPM comparator step 804. In some aspects, this method may offer a complementary or alternative means of attack detection, potentially enhancing the overall robustness of the misbehavior detection system.

The CPM reconstruction step 802 may involve using advanced algorithms, such as machine learning or deep learning techniques, to reconstruct a CPM based on the reconstructed environment map 801A. This reconstructed CPM may serve as a reference point, representing the expected perception data for a given scenario. In some cases, the reconstruction process may incorporate historical data, traffic patterns, and other contextual information to generate a more accurate and comprehensive reference CPM. The CPM reconstruction step 802 may utilize a variety of advanced machine learning and deep learning techniques to reconstruct a CPM based on the aggregated environment map. These techniques may include CNNs for processing spatial data, recurrent neural networks (RNNs) for handling temporal sequences, or graph neural networks (GNNs) for modeling complex relationships between objects in the environment. The reconstruction process may also incorporate ensemble methods, combining multiple models to improve accuracy and robustness. In some cases, the system may employ transfer learning techniques, leveraging pre-trained models on large datasets to enhance performance in specific scenarios. The reconstructed CPM may include not only the current state of the environment but also predictions of future states, enabling more comprehensive misbehavior detection.

The CPM comparator step 804 may then analyze the reconstructed CPM against the CPMs 801B received from vehicles reporting potential misbehavior. This comparison may involve sophisticated statistical analysis, feature matching, or other data comparison techniques to identify discrepancies between the expected and reported perceptions. In some instances, the system may employ weighted comparisons, assigning different levels of importance to various CPM fields based on their reliability or criticality in detecting misbehavior.

The CPM comparator step 804 may employ a range of sophisticated analytical techniques to compare the reconstructed CPM with those received from vehicles reporting potential misbehavior. These techniques may include anomaly detection algorithms, such as isolation forests or autoencoders, to identify unusual patterns in the reported data. The system may also utilize time series analysis methods, such as dynamic time warping or hidden Markov models, to compare temporal sequences of CPM data. In some instances, the comparator may implement a multi-stage comparison process, starting with coarse-grained feature matching and progressively refining the analysis for suspicious cases. The weighted comparison approach may be dynamically adjusted based on real-time conditions, with machine learning algorithms continuously optimizing the weighting scheme to improve detection accuracy. Additionally, the system may incorporate contextual information, such as known traffic patterns or weather conditions, to enhance the interpretation of discrepancies between expected and reported perceptions.

In some aspects, the method illustrated in FIG. 8 may offer a more comprehensive approach to misbehavior detection compared to the bounding box method. While the bounding box method focuses primarily on spatial discrepancies using the IoU metric, the CPM reconstruction and comparison method may analyze a broader range of data fields within the CPMs. This approach may allow for the detection of more subtle forms of misbehavior that might not be apparent from spatial information alone. Additionally, the CPM reconstruction method may leverage advanced machine learning techniques to generate expected environmental data, potentially providing a more nuanced baseline for comparison. However, the effectiveness of each method may depend on the specific scenario and the types of attacks being considered, and in some cases, a combination of both approaches may yield a robust misbehavior detection system.

In some aspects, the system may employ advanced data fusion techniques to combine the results from both the bounding box comparison method and the CPM reconstruction method. This multi-modal approach may significantly enhance the system's ability to detect a wide range of misbehaviors and attacks. For instance, the system may use machine learning algorithms to analyze the outputs from both methods simultaneously, potentially uncovering complex patterns of deception that may be difficult to detect using either method alone. Additionally, the system may incorporate temporal analysis, examining sequences of CPMs over time to identify subtle inconsistencies or gradual divergences from expected behavior. This comprehensive approach may enable the system to adapt to evolving attack strategies and maintain robust misbehavior detection capabilities in diverse and dynamic vehicular environments.

In some aspects, the decision process 800 may include additional or alternative steps, depending on the specific requirements of the vehicular network and the capabilities of the MA. For example, the process may include additional steps for error checking, data encryption, or other types of operations. Similarly, the specific methods and techniques used in each step may vary depending on the specific implementation. For instance, in some cases, the MA may use different methods or protocols to initiate the certificate revocation process. For example, the MA may send the revoke request directly to the malicious vehicle, or it may send the request to a network management entity that has the authority to revoke the vehicle's access. The MA may also use different communication channels or protocols to broadcast the revocation notice, depending on the specific requirements of the vehicular network and the capabilities of the vehicles and infrastructure.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the presented example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A system for vehicular misbehavior detection, comprising:
a vehicular network; and
a misbehavior authority in communication with vehicles in the vehicular network, the misbehavior authority configured to:
receive a misbehavior report from at least one of the vehicles in the vehicular network, the misbehavior report based on a determined discrepancy between a collective perception message (CPM) received from a malicious vehicle and sensor data of the at least one of the vehicles,
receive sensor data from the vehicles in the vehicular network,
generate an environment map based on the sensor data received from the vehicles in the vehicular network,
analyze the misbehavior report by comparing information in the misbehavior report with the generated environment map, and
initiate a certificate revocation process for the malicious vehicle if the misbehavior report is verified.

2. The system of claim 1, wherein the sensor data received from the vehicles in the vehicular network includes at least one of radio frequency (RF) signals, video data, radar data, and intra-sensor communication signals.

3. The system of claim 1, wherein generating the environment map comprises using a deep learning-based tomography technique to process the sensor data received from the vehicles in the vehicular network.

4. The system of claim 1, wherein analyzing the misbehavior report comprises:
creating a first bounding box based on the generated environment map;
creating a second bounding box based on information in the misbehavior report; and
calculating an Intersection over Union (IoU) metric between the first and second bounding boxes.

5. The system of claim 4, wherein analyzing the misbehavior report comprises comparing the calculated IoU metric against a predefined confidence threshold.

6. The system of claim 1, wherein analyzing the misbehavior report comprises:
reconstructing the CPM based on the generated environment map;
comparing the reconstructed CPM with the CPM received from the vehicle reporting misbehavior; and
determining if an attack has occurred based on the comparison.

7. The system of claim 6, wherein comparing the reconstructed CPM with the received CPM comprises calculating a weighted sum of differences between corresponding fields in the reconstructed CPM with the received CPM.

8. The system of claim 1, wherein the misbehavior authority is further configured to broadcast an updated CPM message to other vehicles in the vehicular network after initiating the certificate revocation process.

9. The system of claim 1, wherein the misbehavior authority is integrated within a 5G core network.

10. The system of claim 9, wherein initiating the certificate revocation process comprises sending a revoke request to a Session Management Function (SMF) in the 5G core network.

11. A method for vehicular misbehavior detection, comprising:
receiving, by a misbehavior authority in communication with vehicles in a vehicular network, a misbehavior report from at least one of the vehicles in the vehicular network, the misbehavior report based on a determined discrepancy between a collective perception message (CPM) received from a malicious vehicle and sensor data of the at least one of the vehicles;
receiving, by the misbehavior authority, sensor data from the vehicles in the vehicular network;
generating, by the misbehavior authority, an environment map based on the sensor data received from the vehicles in the vehicular network;
analyzing, by the misbehavior authority, the misbehavior report by comparing information in the misbehavior report with the generated environment map; and
initiating, by the misbehavior authority, a certificate revocation process for the malicious vehicle if the misbehavior report is verified.

12. The method of claim 11, wherein the sensor data received from the vehicles in the vehicular network includes at least one of radio frequency (RF) signals, video data, radar data, and intra-sensor communication signals.

13. The method of claim 11, wherein generating the environment map comprises using a deep learning-based tomography technique to process the sensor data received from the vehicles in the vehicular network.

14. The method of claim 11, wherein analyzing the misbehavior report comprises:
creating a first bounding box based on the generated environment map;
creating a second bounding box based on information in the misbehavior report; and
calculating an Intersection over Union (IoU) metric between the first and second bounding boxes.

15. The method of claim 14, wherein analyzing the misbehavior report comprises comparing the calculated IoU metric against a predefined confidence threshold.

16. The method of claim 11, wherein analyzing the misbehavior report comprises:
reconstructing the CPM based on the generated environment map;
comparing the reconstructed CPM with the CPM received from the vehicle reporting misbehavior; and
determining if an attack has occurred based on the comparison.

17. The method of claim 16, wherein comparing the reconstructed CPM with the received CPM comprises calculating a weighted sum of differences between corresponding fields in the reconstructed CPM with the received CPM.

18. The method of claim 11, comprising broadcasting, by the misbehavior authority, an updated CPM message to other vehicles in the vehicular network after initiating the certificate revocation process.

19. The method of claim 11, wherein the misbehavior authority is integrated within a 5G core network.

20. The method of claim 19, wherein initiating the certificate revocation process comprises sending a revoke request to a Session Management Function (SMF) in the 5G core network.
